(19) United States
(12) Patent Application Publication
(10) Pub. No.: US 2005/0244585 A1
(43) Pub. Date: Nov. 3, 2005

(54) Method and Apparatus for Spray Paint Marking

(76) Inventor: Glenn E Schmeling, Slinger, WI (US)

Correspondence Address: JOHN K. MCCORMICK, 6781 GLACIER DRIVE, WEST BEND, WI, 53090, US

(21) Appl. No.: 10/709,359

(22) Filed: Apr. 29, 2004

(51) Int. Cl. B05D 7/00; B05C 15/00

(52) U.S. Cl. 427/421.1; 118/300

(57) ABSTRACT

A single and/or multiple spray paint railroad track and/or railroad tie marking method and lightweight apparatus is provided which has rollers to guide and easily move the device on the railroad tracks over the railroad track and/or ties to be spray paint marked for replacement. In its preferred embodiment, the multiple spray paint cans are positioned and connected to simultaneously mark the top side of both outer ends of a railroad tie, and optionally an inner portion of the railroad tie, with a single activation of a trigger mechanism in order to assure that both ends, an optionally an inner portion, of a selected railroad tie is plainly marked for the railroad tie replacement gang. In its alternative embodiment, the spray paint cans are mounted to spray paint mark the inside surface of the railroad track above the railroad tie chosen for replacement. The removable push handle and fixed carrying handle allow for compact and easy transportation to and from the job site. The optional spray paint can trays provide for a safe and easy means for carrying along extra spray paint cans and for retaining spent spray paint cans for proper disposal at a later time. The use of the optional spray paint shields provides for more accurate paint application by reducing the effects of wind and wind gusts and for shielding parts of the apparatus from the accumulation of unwanted paint. The use of a shaped spray paint nozzle provides a method and apparatus for shaping the spray paint exiting from the spray paint cans. Depending upon the shape of the spray paint nozzle, the resulting spray paint mark could be something other than a simple spray paint circle. For example, the resulting spray paint could be a long line, a circle with a hole in it, an “X”, or any other shape suitable to a nozzle design. The spray paint nozzle design can also include a spray paint nozzle clip which allows for the positioning of the spray paint nozzle in any orientation desired by the user. The spray paint nozzle designs have other applications than just for the marking of railroad tracks and/or railroad ties and those designs and uses would be apparent to anyone skilled in the art.

### BACKGROUND OF INVENTION

The present invention relates generally to the servicing of railroad ties, and in particular to a device and a method for marking railroad track and railroad ties for identifying which railroad ties are scheduled for removal and replacement.

Wood has traditionally been, and will probably continue to be, the predominant material for railroad track ties. Wood has several advantages over alternative tie materials, such as concrete. Wood is a renewable natural resource and is available in many parts of the world at reasonable costs. Another important advantage of wood is its natural resiliency, which enables wooden railroad ties to absorb the dynamic loads that are associated with railroad traffic. Wooden railroad ties tend to be lighter than comparable concrete railroad ties, and therefore can be relatively easily handled by installation and maintenance crews and equipment.

A significant disadvantage of wooden railroad ties is that they are susceptible to deterioration and decay. Since wood is a cellulose material, it is subject to damage from fungus, decay, termite infestation, the stress and strain of railroad usage and exposure to the elements in unprotected outdoor environments. Railroad ties are particularly susceptible to damage and deterioration in the railroad tie ends and in the connection areas adjacent to each end where the tracks are attached to the railroad ties. The typical construction of railroad track involves the placement of railroad ties about eighteen to thirty inches apart on a roadbed of ballast comprising crushed rock or the like. A pair of steel plates is then placed on the connection areas of each railroad tie to support the rails, and spikes are driven through the plates into the railroad ties, the spike heads securing the rails in place by clamping the lower rail flanges to the plates.

The spikes penetrate the interior portions of the railroad ties and often split open the railroad tie ends. Under railroad traffic, these connection areas are naturally subjected to more stress than any other part of the railroad tie, whereby the railroad ties tend to experience the greatest amount of wear. Moreover, the plates tend to collect and retain moisture, thereby exacerbating deterioration at the railroad tie ends. Although preservatives are commonly applied to structural wooden members that will be exposed to the natural elements, the protection provided by such preservatives tends to lessen over time because the preservatives are susceptible to the deteriorating effects of sunlight, precipitation, freeze-thaw cycles, and so forth. Thus, the useful service life of a railroad tie is generally limited.

There have been many useful inventions and attempts to increase the useful life of the railroad ties. However, at some point in the life of the railroad tie, it becomes decayed or damaged to the point that there is no other alternative but to remove the railroad tie and replace it with a new railroad tie. This activity is generally accomplished with a railroad gang, consisting of about 50 to 70 members in the gang, and the necessary equipment, tools and supplies.

In general, the activity of identifying and replacing deteriorated railroad ties follows the following process. About one year prior to the railroad gang arriving to work on the railroad track, a designated railroad employee walks down the middle of the railroad track examining each of the railroad ties for deterioration. Since the ends of the railroad tie are generally the areas most susceptible to deterioration, the person walking down the center of the railroad track can view both ends fairly readily. On identifying a railroad tie that has deteriorated to the point that it needs replacement, this person marks the inside of one of the railroad tracks near the middle of the railroad tie that needs replacement with a paint, dye or ink marking device and canister of marking material.

Generally, the canister has a felt tip on one end such that when the person applies pressure between thee felt tip and the railroad track, a circular dab of marking material is left on the inside of the railroad track. Each year, a different color of marking material is chosen so that the railroad gang knows which railroad tie is to be removed and replaced as identified by the corresponding marked railroad track.

When the railroad gang arrives, one of the railroad gang members takes a hand held marking device that comprises a long handle, a trigger mechanism, a spray paint can holder and a can of spray paint. This person then proceeds to walk about one quarter of a mile or more down one of the outside edges of the railroad line, on the opposite side from the railroad track that was marked earlier by the designated railroad employee. This enables the gang member to see the previously placed mark on the inside of the opposite railroad track. When this person sees a mark on the opposite inside railroad track, he or she then marks the top side of the end of the railroad tie that has the previously placed mark on the railroad track with the hand held marking device and spray paint. After traveling about a quarter of a mile or more down the track, marking all of the railroad ties that need to be replaced, this person turns around and goes to the opposite side of the railroad track. He or she then proceeds to walk back down the railroad track looking for the opposite railroad tie ends that they previously marked with their hand held spray paint marking device. When they spot a railroad tie that has been marked on the other side of the track, they then proceed to mark the top side of the end of the same railroad tie that is on their side of the railroad track. This is done to ensure that both ends of the railroad tie are marked for removal and replacement.

Once the deteriorated railroad ties have been marked on the top side of both ends of the railroad ties, the rest of the gang crew can begin the process of replacing the railroad ties. This process starts with two spike extraction crews, one on each railroad track that consists of operators and a machine that goes down the railroad line removing the spikes from the marked railroad ties. The spike removal crew removes spikes from those railroad ties that they can see have been clearly marked on the top of the railroad tie by the railroad gang member that did the marking.

The spike extraction crews are followed by a railroad tie removal crew and a machine that removes the old railroad ties. These gang members direct the machines they are operating to seize and remove the railroad ties that they see have been clearly marked on the top of the railroad tie by the railroad gang member that did the marking. Some of these crew members retrieve and collect the railroad plates and spikes.

Sometimes there is a railroad bed repair crew, with a machine, that follows the railroad tie removal crew and prepares the railroad bed for the new railroad tie. Following this is a railroad tie placement crew and a machine that brings in the new railroad ties and places them near the spot where the new railroad tie is to be installed.

Following the railroad tie placement crew is the railroad tie insertion crew. The railroad tie insertion crew operates a machine that inserts the new railroad ties, places the plates onto each railroad tie and pounds the spikes into place to secure the railroad track to the railroad ties. Following this, a mile or so farther back down the railroad line is another crew that straightens and cleans up the railroad line and the railroad bed.

While this process and procedure ultimately gets the older deteriorated ties replaced, there are some errors, problems and inefficiencies that occur in the existing procedure. During the process wherein the railroad gang member walks down the railroad line marking the railroad ties based upon the prior mark on the railroad track by the designated railroad employee, there are occasions where the railroad gang member fails to see or misses one of the designated railroad employee's marks and fails to mark a railroad tie end or ends. Similarly, when the railroad gang crew member turns around and proceeds down the opposite side of the track to mark the railroad tie ends on the opposite side of the track, there are occasions when a railroad tie end is left unmarked on that side of the track even though the other end of the railroad tie is marked for replacement. When this occurs, there are multiple consequences to the railroad gang, railroad track and the railroad company.

If only one end of a railroad tie that is scheduled for replacement is marked, then only one end of the railroad tie has its spikes removed by the spike removal crew on that track. When the railroad tie removal crew arrives to remove the marked railroad tie, one of two events can happen. One possibility is that the spike extraction crew sees that one end of the railroad tie has not had its spikes removed and stops the process of removing the railroad ties. This crew then calls a halt to the work in front of them and calls back the spike removal crew to have the spikes removed. This typically causes a delay of about ten minutes for the majority of the 50 to 70 person crew each time the spike removal crew is called back. Once the spikes are removed, the rest of the railroad tie removal and installation begin again.

The other possibility, if the spikes have not been removed on one side of the railroad tie, is that the railroad tie removal crew does not see the existing spikes and attempts to remove the railroad tie. This can cause the railroad tie to break in half and/or cause the railroad track to twist or warp. When this occurs, the work stops, the spike removal crew is called back to remove the remaining spikes, the railroad tie is removed and the railroad tie installation process continues again. Depending upon the condition of the railroad track, this can cause significant additional delays to the entire crew. In addition to this, the railroad track and bed cleanup crew following about a mile behind this crew has additional work to cleanup the railroad bed and straighten out the bent railroad track.

If both ends of the railroad tie, that is scheduled to be replaced, still has the spikes in the railroad tie the same scenario occurs as when only one end is left unmarked. If the railroad tie removal crew sees that the spikes are still in the railroad tie, they stop all work and call back the spike extraction crew to remove the spikes thus causing additional delays in the progress of work. If the railroad tie removal crew does not see that the spikes are still in place at both ends of the railroad tie and try to remove the railroad tie, significant damage can occur. The only difference to the damage is in the magnitude of the damage to the railroad track if the railroad tie removal crew attempts to remove the railroad tie when the spikes are still in both ends of the railroad tie. Obviously, there is a greater possibility of more extensive damage to the railroad track, railroad bed, the removal equipment and to the safety of the railroad gang members.

Thus, the job of clearly marking the railroad track and the job of clearly marking the railroad tie for tie removal is crucial to maintaining the railroad track and to the productivity and efficiency of the railroad gang and to the company. Unfortunately, the job of marking the railroad track and ties is somewhat monotonous and boring, further leading to more errors and missed markings of railroad ties needing replacement.

The prior art method of marking the railroad track and the railroad ties is, therefore, only as accurate and reliable as the individuals who are marking the railroad track and the methods and apparatus used to mark both ends of the designated railroad ties. Therefore, a need exists to for an improved system of plainly marking railroad track and deteriorated railroad ties in a manner that assures that the deteriorated railroad ties are plainly marked for the railroad gang and that the method of marking is accomplished in a more efficient, and less boring, manner.

### SUMMARY OF INVENTION

The present invention provides for a method and apparatus which overcomes the limitations described above by providing a lightweight mobile spray painting device in which a plurality of spray paint cans are selectively mounted on both ends and/or in the center of the apparatus allowing the operator to selectively mark the exposed surfaces of a railroad tie in a multitude of locations at the same time. In the alternative, a single spray paint can, or multiple spray paint cans, can be mounted underneath the main frame of the apparatus, in a horizontal position, to be used selectively to spray paint mark a railroad track above a railroad tie chosen for replacement.

In use, the apparatus is transported to the work site wherein a railroad gang member and/or employee places the apparatus on the railroad track and attaches the push handle. The railroad gang member and/or railroad employee then fills up the optional spray paint can trays with spray paint cans and loads a spray paint can into each of the available spray paint can holders or only into the desired spray paint can holders. The railroad gang member and/or employee then proceeds to travel down the railroad track pushing the apparatus in front of him or her.

In its alternate embodiment, when the railroad employee spots a railroad track that requires replacement, the railroad employee positions the apparatus over the appropriate railroad tie and activates the spray paint can in the spray paint can holder by activating the triggering mechanism located on the push handle near the handle grip. The result is a single or simultaneous multiple spray paint marking of the railroad track designating the railroad tie underneath it for replacement. The railroad employee can push the apparatus forward or backward slightly to give the spray paint a wider spray paint mark while the triggering mechanism is activated. The railroad employee then releases the triggering mechanism and proceeds down the railroad track until they identify another railroad tie that needs replacement and activates the apparatus accordingly. At the end of his or her designated walk, the railroad employee then turns around and walks back down the track, pushing or pulling the apparatus with them, to where he or she started work.

In its preferred embodiment, when the railroad gang arrives, one of the railroad gang members is chosen to mark all of the railroad ties in need of replacement. The railroad gang member places the apparatus on the railroad track and attaches the push handle. The railroad gang member then fills up the optional spray paint can trays with spray paint cans and loads a spray paint can into each of the available spray paint can holders. The railroad gang member then proceeds to travel down the railroad track pushing, or pulling, the apparatus in front of or behind him or her.

When the railroad gang member spots a railroad track that has been previously marked by a prior railroad employee, the railroad gang member positions that apparatus over the appropriate railroad tie and activates the spray paint can in the spray paint can holder by activating the triggering mechanism located on the push handle near the handle grip. The result is the simultaneous multiple spray paint marking of the railroad tie designated for replacement. The railroad employee can push the apparatus forward or backward slightly to give the spray paint a wider spray paint mark while the triggering mechanism is activated. The railroad gang member the releases the triggering mechanism and proceeds down the railroad track until they identify another railroad tie that requires replacement and activates the apparatus accordingly. The railroad employee then releases the triggering mechanism and proceeds down the railroad track until they identify another railroad tie that needs replacement and activates the apparatus accordingly. At the end of his or her designated walk, the railroad gang member then turns around and walks back down the railroad track to the rest of the railroad gang with the apparatus.

In this manner, the operator and the rest of the gang crew can be assured that all of the appropriate railroad ties are plainly marked at both ends of the railroad tie and in any other railroad tie location so desired by the railroad gang crew. This means of simultaneous multiple marking of the railroad ties reduces the time and effort required by the operator to mark both ends of the railroad ties. This device also allows the rest of the railroad gang to perform their job functions with less errors and mistakes thereby saving lost time, improving productivity and reducing costs.

The present invention provides for a reasonably accurate perpendicular relationship to the railroad track and a parallel relationship to the railroad ties with the use of a plurality of rollers attached to a roller bracket that is attached to the frame of the present invention. The present invention also allows for the adjustment of the spray paint can triggering mechanism to assure that the spray paint cans are actuated effectively when the invention is utilized.

The optional spray paint can trays provide an easy and safe means for carrying addition spray paint cans and for collecting the spent cans for proper disposal later while the operator is using this device.

The present invention also allows for the easy movement of the device through the use of the push handle and the easy removal of the push handle to allow for the compact storage and reduced damage to the apparatus during transportation to and from the work site. The carrying handle provides for an easy and balanced means for lifting and carrying the device where needed.

The design of the shaped spray paint nozzle provides an apparatus and a means for shaping the spray paint exiting from the spray paint cans into a variety of spray paint patterns. Depending upon the shape of the spray paint nozzle, the resulting spray paint mark could be something other than a simple spray painted circle. For example, the resulting spray paint could be a long line, a circle with a hole in it, an “X”, or any other shape suitable to a nozzle design. The spray paint nozzle design can also include a spray paint nozzle clip which allows for the positioning of the spray paint nozzle in any orientation desired by the user. The spray paint nozzle designs have other applications than just for the marking of railroad ties and those designs and uses would be apparent to anyone skilled in the art.

Other features and benefits of this invention will be readily apparent from the following description of the preferred embodiments and the appended claims.

### BRIEF DESCRIPTION OF DRAWINGS

For a further understanding of the nature and objects of the invention, reference should be made to the following description and appended claims, taken in conjunction with the accompanying drawings, in which like elements are given the same reference numbers. Understanding that these drawings depict only typical embodiments of the invention and are, therefore, not to be construed as limiting the scope and spirit of the invention.

FIG. 1 is a frontal plan view of the apparatus for marking railroad ties situated upon a section of railroad track and ties.

FIG. 2 is an enlarged fragmentary frontal view of the carrying handle and the center cable, pulley and guide bracket particularly showing the cable connections and guide arrangement taken generally along lines I-I in FIG. 1.

FIG. 3 is an enlarged fragmentary frontal view of one end of the apparatus generally taken along line II-II in FIG. 1.

FIG. 4 is an enlarged fragmentary top view of the cable tension adjustment mechanism generally taken along line III-III in FIG. 3.

FIG. 5 is a cross sectional view of the apparatus showing the optional additional spray paint can holders taken generally at line IV-IV of FIG. 1.

FIG. 6 is top view of the apparatus with the optional spray paint can trays loaded with spray paint cans.

FIG. 7 is an enlarged fragmentary view of the attachment of an optional spray paint shield generally taken at line V-V of FIG. 3.

FIG. 8 is a frontal plan view of an alternate apparatus for marking railroad track situated upon a section of railroad track and ties.

FIG. 9 is a frontal view of a spray paint can nozzle.

FIG. 10 is a side view of the spray paint can nozzle shown in FIG. 9.

FIG. 11 is a frontal view of an optional spray paint can nozzle.

FIG. 12 is a side view of the optional spray paint can nozzle shown in FIG. 11.

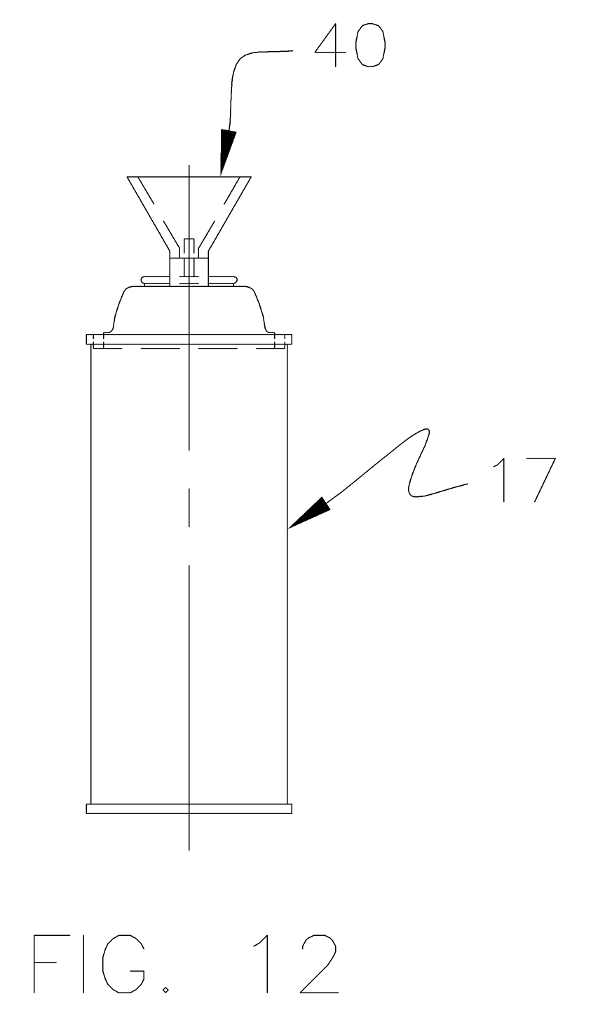

### DETAILED DESCRIPTION

Detailed embodiments of the present invention are disclosed herein as illustrated in the drawings; however it is to be understood that the disclosed embodiments are merely exemplary of the invention, which may be embodied in various forms. In addition, although the invention is described and explained by the use of the inventions application to railroad tracks and railroad ties, there is no intent to limit the invention to the embodiment or embodiments disclosed therein. On the contrary, the intent is to include all alternatives, modifications and equivalents included within the scope and spirit of the inventions as defined by the appended claims.

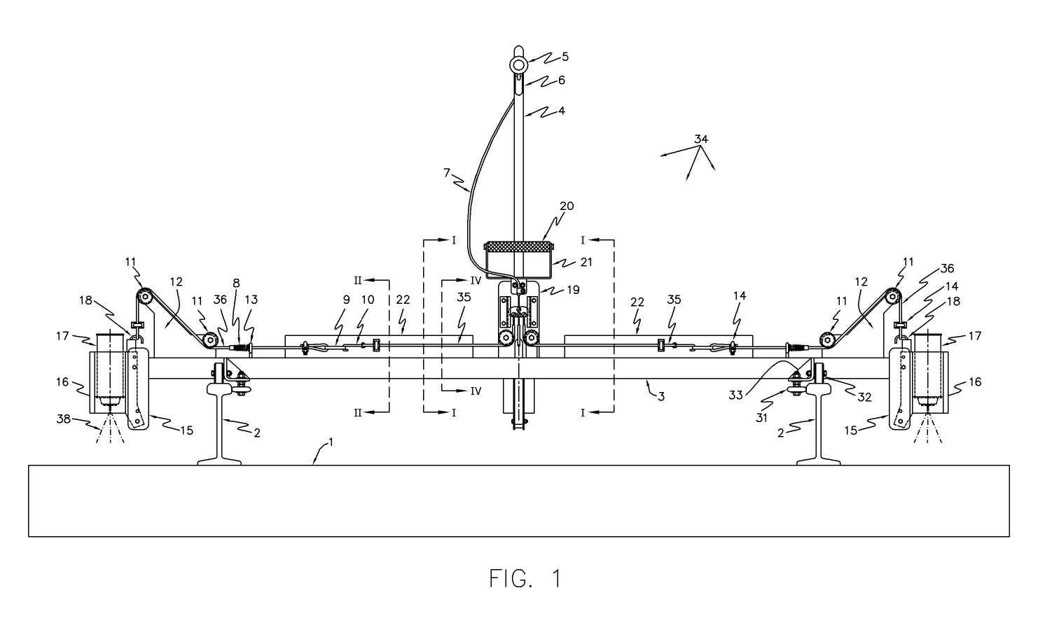

Referring first to FIG. 1, the frontal view of a multiple nozzle paint spray apparatus 34 is generally shown. As will be seen, the apparatus 34, generally comprises a frame 3, a plurality of roller brackets 33, a plurality of guide rollers 31, a plurality of track rollers 32, a plurality of spray paint can holders 16 and spray paint can triggers 18, a push handle 4, a trigger mechanism 6, a carrying handle 20, a plurality of cables 7, 35 and 36 and a plurality of cable pulleys 11.

The frame 3 has connected to it two roller brackets 33. Attached to each roller bracket are a plurality of guide rollers 31 and track rollers 33. The roller brackets 33, guide rollers 31 and track rollers 32 keep the apparatus 34 reasonably centered and aligned on the railroad tracks 2 which are attached to the railroad ties 1.

Attached to the top, at each end of the frame 3, are the end pulley brackets 12. Rotatably attached to the end pulley brackets 12 are a plurality of cable pulleys 11. Attached to each end of the frame 3 are the spray paint can holder brackets 15. Attached to the spray paint can holder brackets 15 are the spray paint can holders 16. Inserted into the spray paint can holders 16 are the spray paint cans 17.

In an alternative arrangement, additional pulley brackets 15, cable pulleys 11, spray paint can holders 16 and spray paint cans 17 can be mounted anywhere along the main frame 3, such as in the middle of the frame 3 as shown in FIG. 1, for additional spray paint marking of the railroad ties 1. Also shown in FIG. 1 are the optional spray paint can trays 22.

Attached at the center of the frame 3 is the center bracket 19 to which is attached the lift handle bracket 21. A lift handle 20 is attached to the lift handle bracket 21 which allows a gang crew member (not shown) to lift and place the apparatus onto the railroad tracks 2 and/or a transportation device such as an automobile or pickup truck (not shown). Also attached to the frame 3 is the push handle bracket 24 (not shown in FIG. 1) to which is removably connected the push handle 4. Attached to one end of the push handle is a handle grip 5 and the spray paint can trigger mechanism 6. The push handle 4 and the push handle grip 5 allow the gang crew member (not shown) to push or pull the apparatus easily up or down the railroad track 2. Attached to the trigger mechanism 6 is the trigger cable 7.

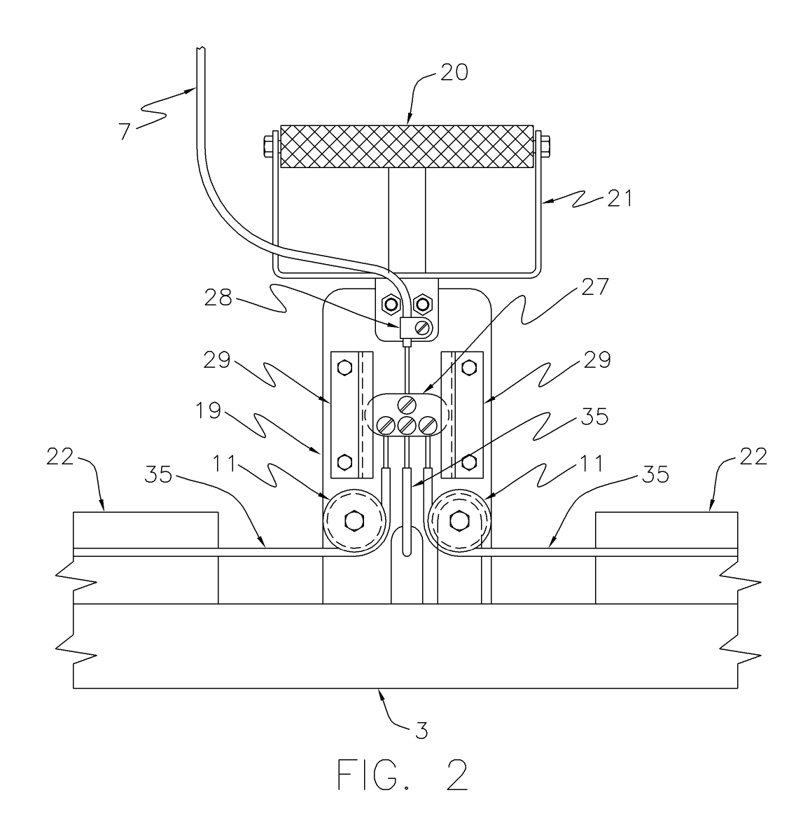

FIG. 2 is an enlarged fragmentary frontal view of the apparatus generally taken along line I-I in FIG. 1. As best shown in FIG. 2, the trigger cable 7 is connected by the cable clip 28 to the cable connector bar 27. The cable connector bar 27 is connected slideably to the center bracket 19 by the use of two guide brackets 29. Also connected to the cable connector bar 27 are a plurality of movable guide cables 35 which are guided and travel along the plurality of cable pulleys 11 shown attached rotatably to the center bracket 19 which is attached to the main frame 3. Also partially shown in FIG. 2 are the two optional spray paint can trays 22.

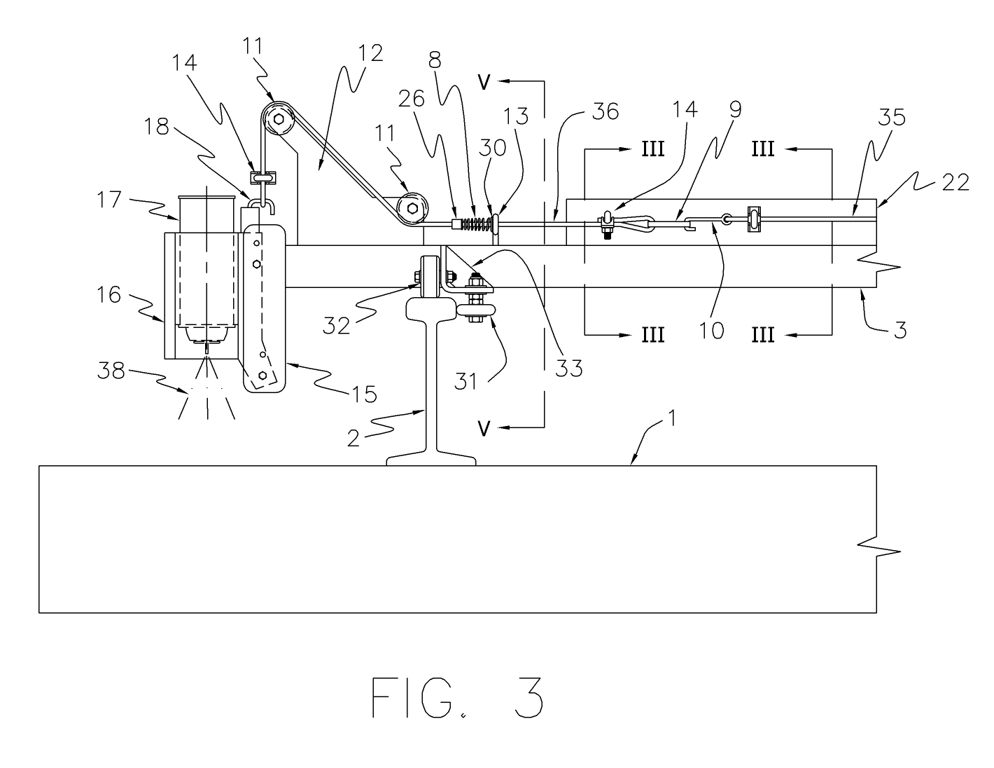

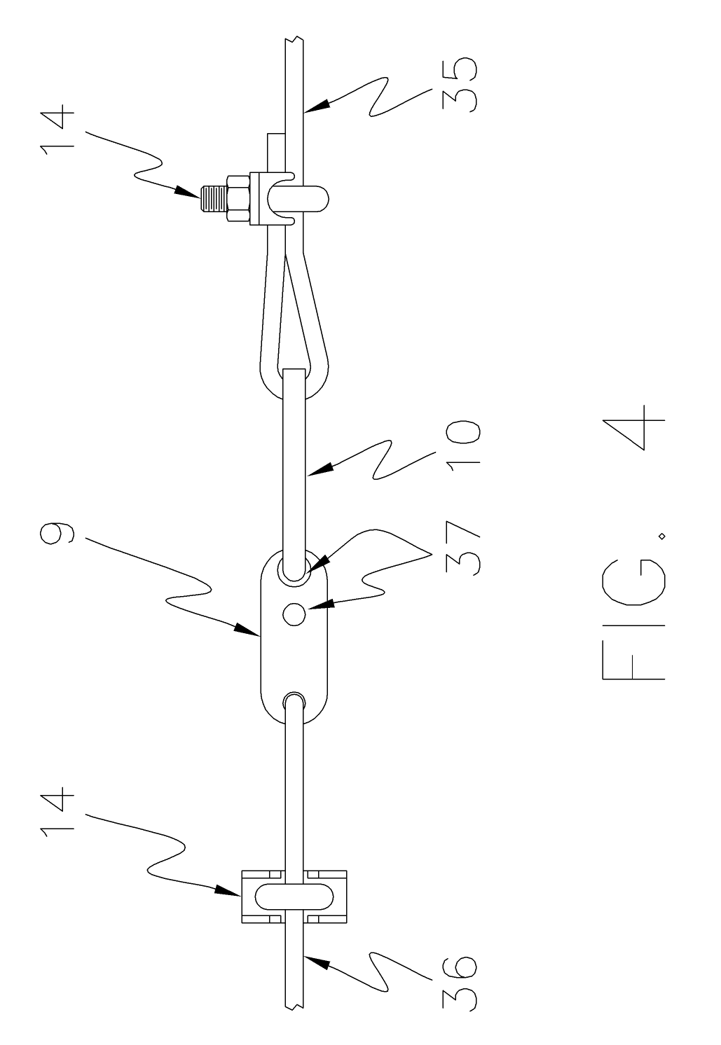

FIG. 3 is an enlarged fragmentary frontal view of the apparatus generally taken along line II-II in FIG. 1. FIG. 3 shows the guide cable 35 attached to one end of the tension adjustment hook 10 through the use of a cable nut 14 (shown in FIG. 4). The tension adjustment hook 10 is removably attached to the tension adjustment bar 9. The spray paint can activation cable 36 is attached to the other end of the tension adjustment bar 9 by the use of a cable nut 14. Each of the outer two spray paint can activation cables 36 pass through an eyebolt 13 which is mounted to the frame 3 near the outer ends of the frame 3. On the outside edge of the eyebolt 13 there is a cable crimp 26 attached to the spray paint can activation cable 36 which holds in place a tension spring 8 and a fender washer 30. The tension spring 8 and the fender washer 30 move compressably along the spray paint can activation cable 36 between the cable crimp 26 and the eyebolt 13 while maintaining tension on the spray paint can activation cable 36, the tension adjustment bar 9, the tension adjustment hook 10, the guide cable 35, the cable connector bar 27 (shown in FIG. 2) and the trigger cable 7 (shown in FIG. 2) by butting up snuggly against the eyebolt 13.

The other end of the spray paint can activation cables 36 are connected to the spray paint can triggers 18 by the use of cable nuts 14. The spray paint can activation cables 36 travels and is guided by the plurality of cable pulleys 11 mounted on the end pulley brackets 12.

FIG. 4 is an enlarged fragmentary view generally taken along line III-III of FIG. 3. FIG. 4 shows the tension adjustment bar 9 which has a plurality of holes 37 through which the tension adjustment hook 10 can be positioned in. By moving the tension adjustment hook 10 into one of the plurality of holes 37 in the tension adjustment bar 9, the proper tension on the spray paint can activation cable 36, the tension adjustment bar 9, the tension adjustment hook 10, the guide cable 35, the cable connector bar 27 (shown in FIG. 2) and the trigger cable 7 (shown in FIG. 2) can be maintained and/or adjusted.

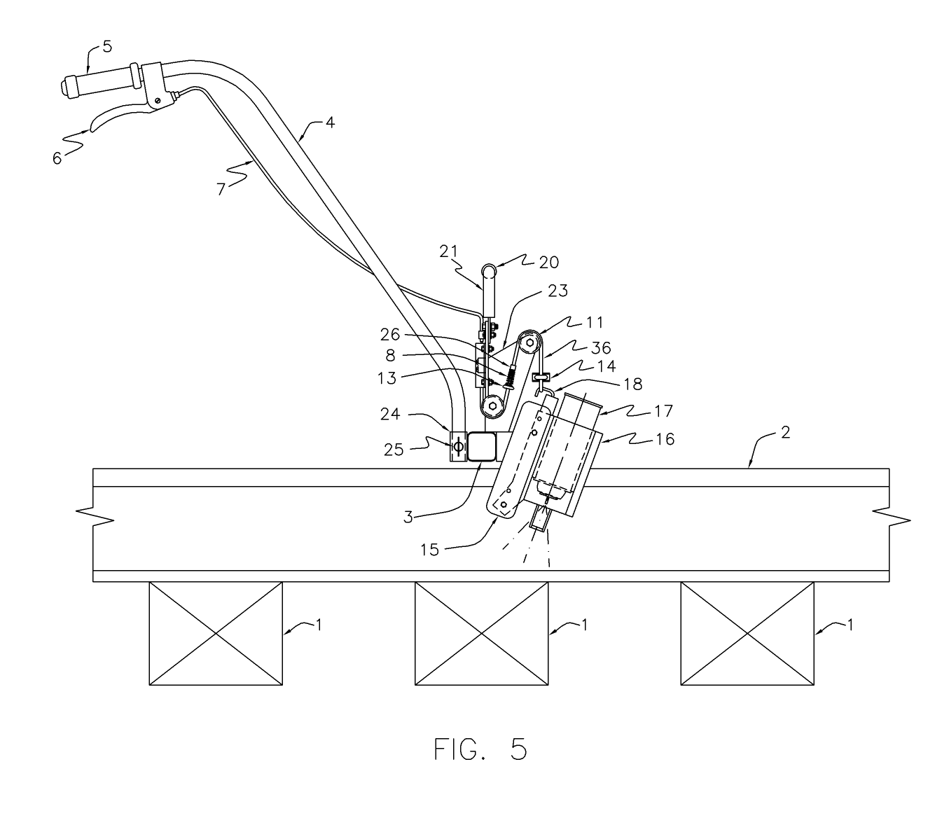

FIG. 5 shows a cross sectional view of the apparatus taken generally at line IV-IV of FIG. 1. The frame 3 has the push handle bracket 24 connected to it. The push handle 4 is removably placed into the push handle bracket 24 and held in place by a quick release pin 25. This arrangement allows for the removal of the push handle 4 for easier transportation to and from a job site and for less damage to the push handle 4 while in transit. Also shown attached to the push handle are the handle grip 5 and the trigger mechanism 6.

In an alternate embodiment, FIG. 5 shows an example of an additional center pulley bracket 23 attached to the frame 3. Attached to the center pulley bracket 23 is a plurality of rotatable cable pulleys 11. Attached to the cable connector bar (not shown) is an additional spray paint can activation cable 36 which moves and is guided by the rotatable cable pulleys 11. The spray paint can activation cable 36 is attached at the other end to another paint can holder spray trigger 18 by the use of a cable nut 14. The spray paint can trigger 18 is movably mounted in a spray paint can holder 16 which is attached to a spray paint can holder bracket 15. The spray paint can holder bracket 15 is mounted to the main frame 3.

When the gang member (not shown) activates the trigger mechanism 6 (shown in FIG. 1), it lifts the trigger cable 7 (shown in FIG. 1) which in turn moves the cable connector bar 27 (shown in FIG. 2), the guide cables 35 (shown in FIG. 2), the tension adjustment hook 10 (shown in FIG. 3), the tension adjustment bar 9 (shown in FIG. 3), the spray paint can activation cable 36 (shown in FIG. 3) and the spray paint can triggers 18 (shown in FIG. 3) which in turn simultaneously activates a plurality of spray paint cans 17 (shown in FIG. 1) allowing spray paint 38 (shown in FIG. 1) to exit the spray paint can 17 and mark the railroad tie 1 (shown in FIG. 1) with a plurality of spray paint 38 marks.

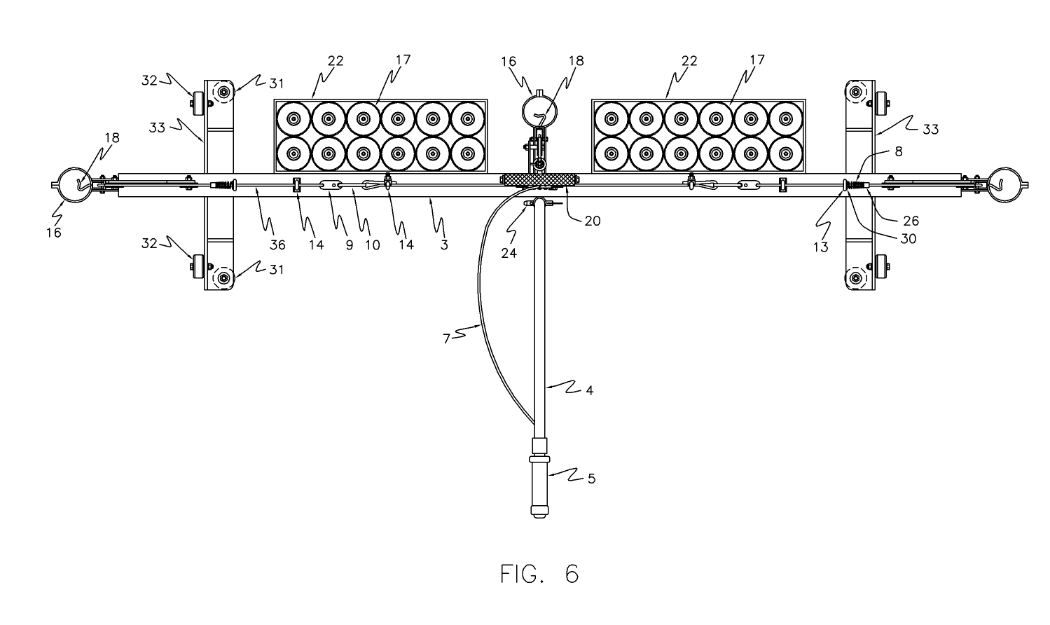

FIG. 6 shows a top view of another optional embodiment of the apparatus. Attached to the frame 3 are one or more spray paint can trays 22 which can hold a plurality of spray paint cans 17 for storage. The spray paint can trays 22 can be either permanently mounted or removably attached.

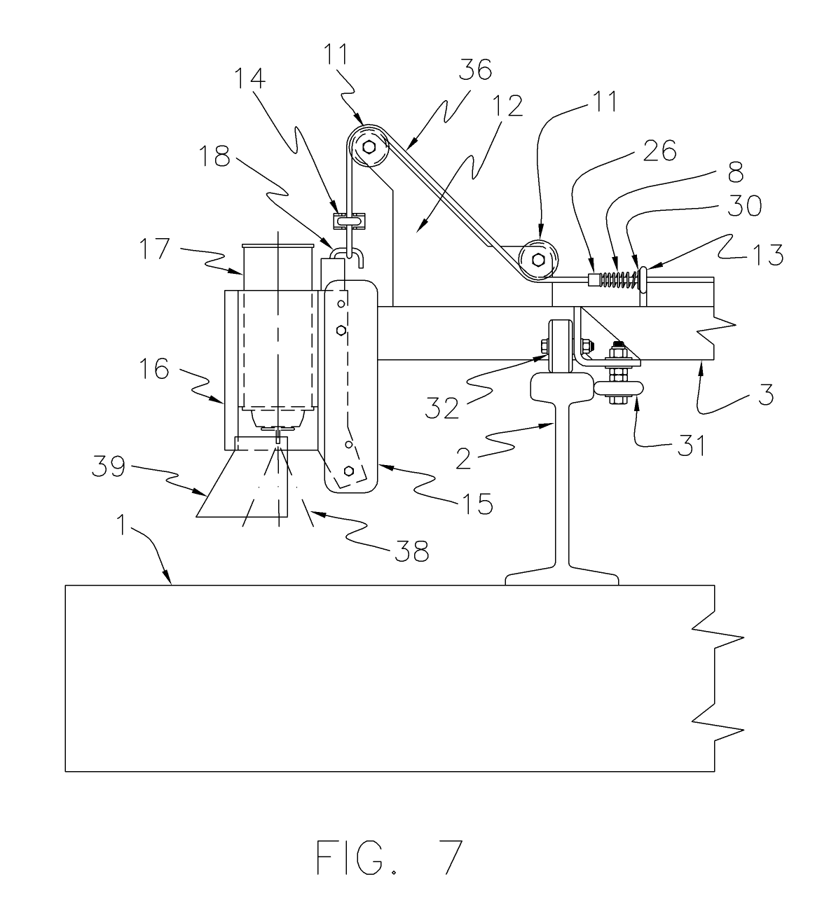

FIG. 7 is an enlarged fragmentary view taken generally along line V-V of FIG. 3. FIG. 7 shows the attachment of an optional spray paint shield 39 attached to the spray paint can holder 16 and extending downward below the spray paint can holder 16 and above the railroad tie 1. The spray paint shield 39 is made of stiff but flexible material such that if the shield encounters obstructions during the use of the apparatus 34 (shown in FIG. 1) the shield will yield to the obstruction without breaking or being permanently distorted. The spray paint shield 39 can either encircle the entire spray paint can holder 16 or only a portion thereof. The purpose of the spray paint shield 39 is to reduce and/or eliminate the effects that wind currents and/or gusts have on the location and spray pattern of the paint 38.

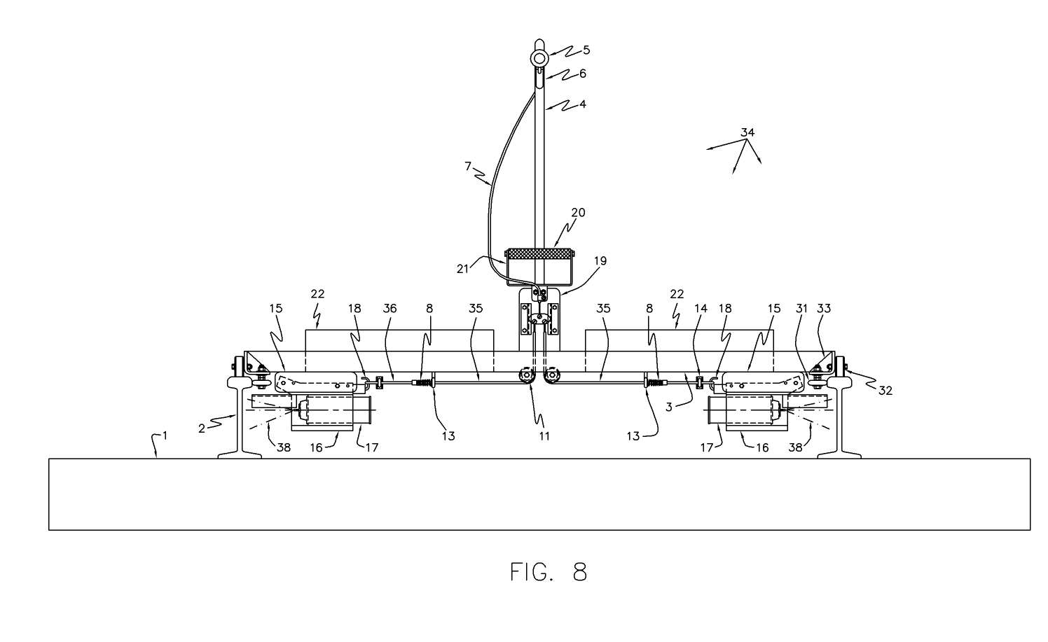

FIG. 8 shows an alternate frontal view of the apparatus 34. In this alternate embodiment, there are only two spray paint can holders 16 which are mounted in a horizontal position underneath the main frame 3 through the use of the spray paint can holder brackets 15. The operator can choose to insert only one can of spray paint 17 into one of the spray paint can holders 16 in order to mark only one inside railroad track 2, or they can insert one spray paint can 17 into each of the spray paint can holders 16 in order to mark the insides of both of the railroad tracks simultaneously. This alternative embodiment also shows the relocation of the cable pulleys 11, the guide cable 35, the eyebolts 13, and the spray paint can activation cables 36. Optionally, this embodiment also includes a spray paint shield 39 and the optional spray paint can trays 22. The method of operating the alternative embodiment is the same as the preferred embodiment.

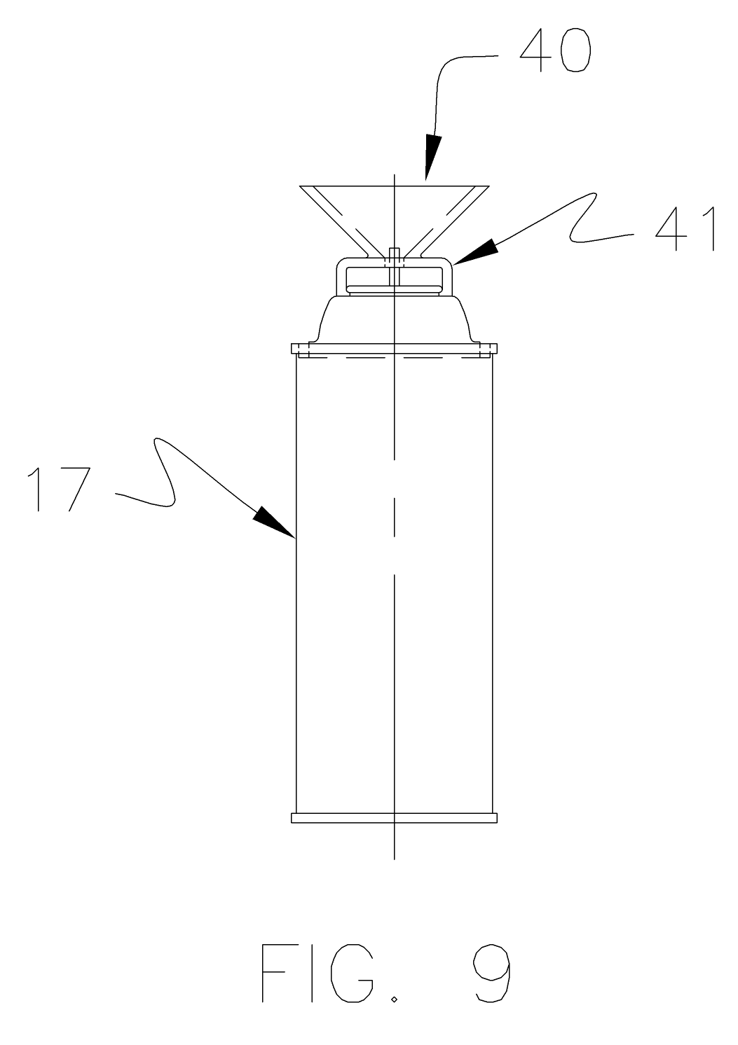

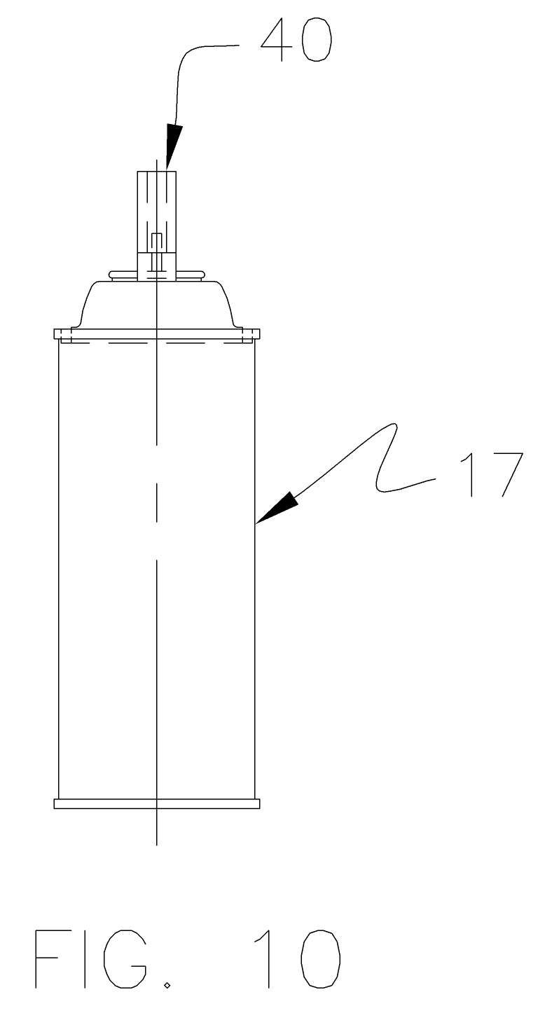

FIG. 9 and FIG. 10 show the frontal view and side view respectively, of a spray paint can 17 affixed with an optional spray paint nozzle 40. The spray paint nozzle 40 shown in FIG. 9 and FIG. 10 is designed with a fan type shape such that the exiting paint 38 (not shown) is applied in a long line on the railroad tie 1 (not shown). The spray paint nozzle clip 41, which is a part of the spray paint nozzle 40, attaches to the spray paint can 17. When the spray paint can 17 with the spray paint can nozzle 40 and clip 41 are inserted into the spray paint can holders 16 (not shown), the spray paint nozzle clip 41 aligns and fits in with a mating slot in the spray paint can holder 16 (not shown) such that the spray paint nozzle 40 fan is positioned to spray paint 38 (not shown) in a line parallel with the length of the railroad tie 1 (not shown). This provides for a wider spray paint 38 mark on the railroad tie 1 to permit easier identification of those railroad ties 1 scheduled for replacement.

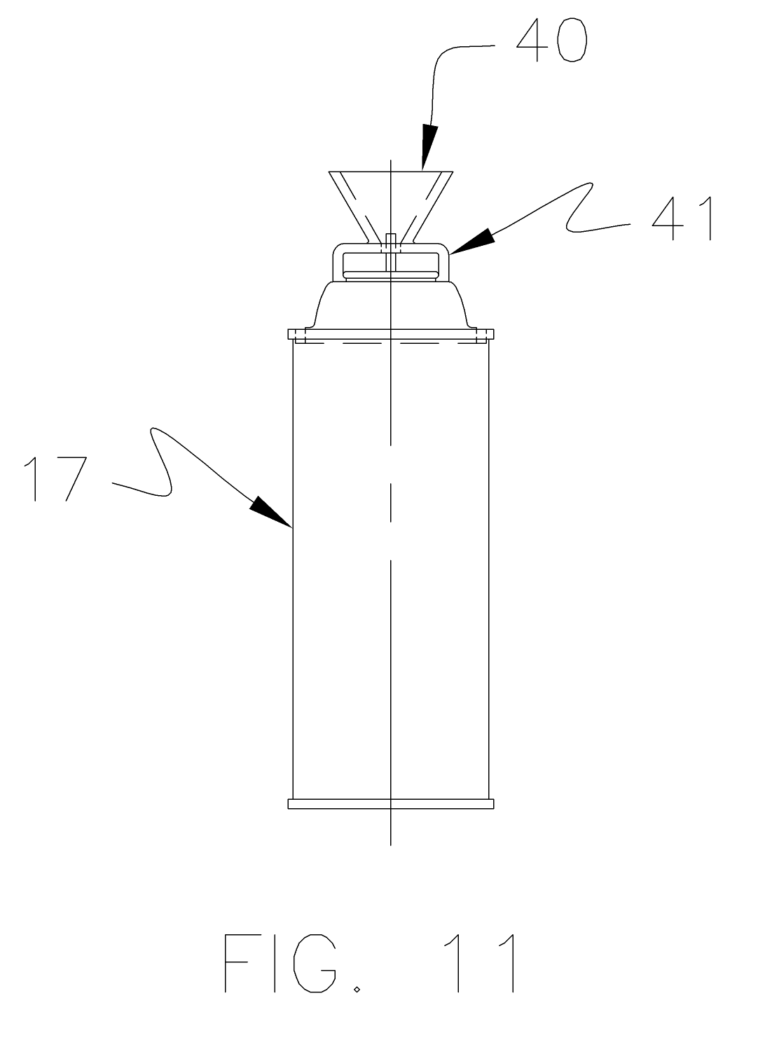

An alternative design to the spray paint nozzle 40 is depicted in a frontal view in FIG. 11 and in a side view in FIG. 1 2. In this embodiment, the spray paint nozzle 40 is cone shaped to provide a wider cylindrical spray paint 38 (not shown) pattern for easier viewing. The spray paint nozzle clip 41 would not necessitate aligning and mating with a slot in the spray paint can holder 16 (not shown) as the resulting spray paint 38 mark would be cylindrical in shape. Other spray paint nozzle 40 shapes and clips 41 would be readily apparent to anyone skilled in the art.

1. A method and an apparatus for spray painting,
a. wherein said apparatus includes:
i. a shaped spray paint nozzle attached to a spray paint can, wherein said shaped nozzle forces the exiting paint to take on the shape and form of the shaped nozzle; and
b. wherein said method comprises the steps of:
i. directing the said shaped nozzle in the desired direction; and
ii. pressing the said shaped nozzle which causes spray paint to exit the said shaped nozzle in the form and shape of the said shaped nozzle.

2. A method and an apparatus as recited in claim 1,
a. wherein said apparatus includes:
i. a spray paint nozzle clip attached to, or a part of, the said spray paint nozzle;
ii. said spray paint nozzle and clip attached to a spray paint can; and
iii. said spray paint can with attached spray paint nozzle inserted into a spray paint can holder designed to mate with the said nozzle clip to assure proper positioning of the shaped nozzle; and
b. wherein said method comprises the additional steps of:
i. inserting the said spray paint can with the said spray paint nozzle and clip attached to the said spray paint can into a spray paint can holder that has a mating slot designed to accept the spray paint nozzle clip in order to assure the said shaped nozzle is aligned in the orientation defined by the mating slot in said spray paint can holder;
ii. directing the said spray can holder in the desired direction; and
iii. providing a means for activating the said shaped spray paint nozzle which causes spray paint to exit the said spray paint can and the said shaped nozzle in the form and shape of the said shaped nozzle.

3. A method for spray paint marking railroad ties using a multiple nozzle spray paint apparatus,
a. wherein said apparatus comprises:
i. a plurality of spray paint cans held in a plurality of spray paint can holders;
ii. said spray paint can holders having a trigger mechanism for releasing paint from the said spray paint cans;
iii. said spray paint can holders being attached either fixedly or adjustably in a vertical and/or angular position relative to a horizontal main frame at either end of the said main frame;
iv. a plurality of roller brackets attached horizontally and perpendicular to the said main frame;
v. a plurality of vertically and horizontally mounted rollers rotatably attached to said roller brackets;
vi. a center bracket being attached to said main frame;
vii. a carrying handle and guide brackets attached to said center bracket;
viii. a cable connector bar moveably connected to said center bracket and to a plurality of cables;
ix. a push handle bracket attached to the said main frame;
x. a handle grip and trigger mechanism attached to a push handle, said push handle being removably attached to the said push handle bracket;
xi. of the said plurality of cables, the first said cable is attached to the said push handle trigger mechanism and to the said cable connector bar, two other said cables being connected to the said cable connector bars and to two tension adjustment hooks, the said tension adjustment hooks being further connected to two tension adjustment bars wherein said tension adjustment bars are further connected to another said cable which is connected to said spray paint can holder triggers;
xii. said cables being guided by a plurality of pulley rollers rotatably attached to the said center bracket and to the end pulley brackets;
xiii. said cables being held in tension and in an non-triggering mode by tension spring attached to the said cables along the length of the said main frame; and
b. wherein said method comprises the steps of:
i. positioning the said apparatus on the railroad track in a horizontal position such that the said rollers are in contact with the railroad track and perpendicular to the said railroad tracks;
ii. attaching the said push handle to the said push handle bracket;
iii. placing said spray paint cans in the said spray paint can holders;
iv. moving the said apparatus down the said railroad track by pushing the said push handle attached to the said apparatus;
v. identifying said railroad ties that need to be replaced;
vi. stopping the said apparatus and activating said triggering mechanism such that paint sprays simultaneously from the said plurality of spray paint cans onto the exposed top ends of the said railroad ties;
vii. releasing the said triggering mechanism to stop the said paint from spraying; and
viii. continuing to push the said apparatus down the said railroad track looking for more of the said railroad ties that need to be replaced.

4. A method and apparatus as recited in claim 3,
a. wherein said apparatus includes:
i. additional said spray paint cans inserted in additional spray paint can holders being attached either fixedly or adjustably in a vertical and/or angular position relative to a horizontal main frame at one or more locations along the interior horizontal length of the said main frame;
ii. additional cables being attached to the said cable connector bar which is movable connected to said center bracket;
iii. the said additional cables being attached to the spray paint can holder triggers mounted in the said additional spray paint can holders;
iv. said additional spray paint can holders being mounted to center brackets which are in turn mounted to said frame;
v. said additional cables being guided by a plurality of pulley rollers rotatably attached to the said center brackets;
vi. said cables being held in tension and in an non-triggering mode by tension spring attached to the said cables along the length of the said main frame; and
b. wherein said method includes the additional steps of:
i. placing said spray paint cans in the said additional spray paint can holders; and
ii. stopping the said apparatus and activating said triggering mechanism such that paint sprays simultaneously from the said plurality of spray paint cans onto the exposed top ends of the said railroad ties and on the exposed said railroad tie areas in between the said railroad track.

5. A method and apparatus as recited in claim 3,
a. wherein said apparatus comprises:
i. a plurality of said spray paint cans that have a said shaped spray paint nozzle and clip attached to each said spray paint can;
ii. a plurality of said spray paint can holders, each having a spray paint can nozzle clip opening designed to accept the insertion of the said shaped spray paint can nozzle clip in order to keep the resulting said paint spray aligned with the said railroad track; and
b. wherein said method comprises the additional steps of:
i. placing the said spray paint cans with the attached said shaped spray paint nozzle and clip into the said spray paint can holders such that the said spray paint can nozzle clips are in alignment with the spray paint can holder nozzle clip opening; and
ii. stopping the said apparatus and activating the said triggering mechanism such that paint sprays onto the top surface of the said railroad ties in a shape as defined by the shape of the said shaped spray paint nozzle.

6. A method and apparatus as recited in claim 4,
a. wherein said apparatus comprises:
i. a plurality of said spray paint cans that have a said shaped spray paint nozzle and clip attached to each said spray paint can;
ii. a plurality of said spray paint can holders, each having a spray paint can nozzle clip opening designed to accept the insertion of the said shaped spray paint can nozzle clip in order to keep the resulting said paint spray aligned with the said railroad track; and
b. wherein said method comprises the additional steps of:
i. placing the said spray paint cans with the attached said shaped spray paint nozzle and clip into the said spray paint can holders such that the said spray paint can nozzle clips are in alignment with the spray paint can holder nozzle clip opening; and
ii. stopping the said apparatus and activating the said triggering mechanism such that paint sprays onto the top surface of the said railroad ties in a shape as defined by the shape of the said shaped spray paint nozzle.

7. An apparatus as recited in claim 3, wherein there are flexible spray paint shields attached to the said spray paint can holders.

8. An apparatus as recited in claim 4, wherein there are flexible spray paint shields attached to the said spray paint can holders.

9. An apparatus as recited in claim 5, wherein there are flexible spray paint shields attached to the said spray paint can holders.

10. An apparatus as recited in claim 6, wherein there are flexible spray paint shields attached to the said spray paint can holders.

11. An apparatus as recited in claim 3 wherein there are one or more spray paint can tray holders mounted either removably or fixed to the said main frame.

12. An apparatus as recited in claim 4 wherein there are one or more spray paint can tray holders mounted either removably or fixed to the said main frame.

13. An apparatus as recited in claim 5 wherein there are one or more spray paint can tray holders mounted either removably or fixed to the said main frame.

14. An apparatus as recited in claim 6 wherein there are one or more spray paint can tray holders mounted either removably or fixed to the said main frame.

15. An apparatus as recited in claim 7 wherein there are one or more spray paint can tray holders mounted either removably or fixed to the said main frame.

16. An apparatus as recited in claim 8 wherein there are one or more spray paint can tray holders mounted either removably or fixed to the said main frame.

17. An apparatus as recited in claim 9 wherein there are one or more spray paint can tray holders mounted either removably or fixed to the said main frame.

18. An apparatus as recited in claim 10 wherein there are one or more spray paint can tray holders mounted either removably or fixed to the said main frame.

19. A method for spray paint marking railroad track using a multiple nozzle spray paint apparatus,
a. wherein said apparatus comprises:
i. a singular or a plurality of spray paint cans held in a single or a plurality of spray paint can holders;
ii. said spray paint can holders having a trigger mechanism for releasing paint from the said spray paint cans;
iii. said spray paint can holders being attached either fixedly or adjustably in a horizontal and/or angular position relative to a horizontal main frame at one or more locations along the interior horizontal length of the said main frame;
iv. a plurality of roller brackets attached horizontally and parallel to the said main frame;
v. a plurality of vertically and horizontally mounted rollers rotatably attached to said roller brackets;
vi. a center bracket being attached to said main frame;
vii. a carrying handle and guide brackets attached to said center bracket;
viii. a cable connector bar moveably connected to said center bracket and to a plurality of cables;
ix. a push handle bracket attached to the said main frame;
x. a handle grip and trigger mechanism attached to a push handle, said push handle being removably attached to the said push handle bracket;
xi. of the said plurality of cables, the first said cable is attached to the said push handle trigger mechanism and to the said cable connector bar, two other said cables being connected to the said cable connector bars and to two tension adjustment hooks, the said tension adjustment hooks being further connected to two tension adjustment bars wherein said tension adjustment bars are further connected to another said cable which is connected to said spray paint can holder triggers;
xii. said cables being guided by a plurality of pulley rollers rotatably attached to the said center bracket and to the end pulley brackets;
xiii. said cables being held in tension and in an non-triggering mode by tension spring attached to the said cables along the length of the said main frame; and
b. wherein said method comprises the steps of:
i. positioning the said apparatus on the railroad track in a horizontal position such that the said rollers are in contact with the railroad track and perpendicular to the said railroad tracks;
ii. attaching the said push handle to the said push handle bracket;
iii. placing said spray paint can(s) in the said spray paint can holder(s);
iv. moving the said apparatus down the said railroad track by pushing the said push handle attached to the said apparatus;
v. identifying said railroad ties that need to be replaced;
vi. stopping the said apparatus and activating said triggering mechanism such that paint sprays simultaneously from the said plurality of spray paint cans onto the inside surface of the said railroad track;
vii. releasing the said triggering mechanism to stop the said paint from spraying; and
viii. continuing to push the said apparatus down the said railroad track looking for more of the said railroad ties that need to be replaced.

20. A method and apparatus as recited in claim 19,
a. wherein said apparatus comprises:
i. a plurality of said spray paint cans that have a said shaped spray paint nozzle and clip attached to each said spray paint can;
ii. a plurality of said spray paint can holders, each having a spray paint can nozzle clip opening designed to accept the insertion of the said shaped spray paint can nozzle clip in order to keep the resulting said paint spray aligned with the said railroad track; and
b. wherein said method comprises the additional step of:
i. placing the said spray paint cans with the attached said shaped spray paint nozzle and clip into the said spray paint can holders such that the said spray paint can nozzle clips are in alignment with the spray paint can holder nozzle clip opening.

21. An apparatus as recited in claim 19, wherein there are flexible spray paint shields attached to the said spray paint can holders.

22. An apparatus as recited in claim 20, wherein there are flexible spray paint shields attached to the said spray paint can holders.

23. An apparatus as recited in claim 19 wherein there are one or more spray paint can tray holders mounted either removably or fixed to the said main frame.

24. An apparatus as recited in claim 20 wherein there are one or more spray paint can tray holders mounted either removably or fixed to the said main frame.

25. An apparatus as recited in claim 21 wherein there are one or more spray paint can tray holders mounted either removably or fixed to the said main frame.

26. An apparatus as recited in claim 22 wherein there are one or more spray paint can tray holders mounted either removably or fixed to the said main frame.
